(19) United States
(12) Patent Application Publication
(10) Pub. No.: US 2011/0254991 A1
(43) Pub. Date: Oct. 20, 2011

(54) RECORDING AND REPRODUCING DEVICE FOR RECORDING AND REPRODUCING IMAGE AND SOUND

(75) Inventor: Yasushi Obata, Osaka (JP)

(73) Assignee: SANYO ELECTRIC CO., LTD., Osaka (JP)

(21) Appl. No.: 13/087,991

(22) Filed: Apr. 15, 2011

(30) Foreign Application Priority Data
Apr. 20, 2010 (JP) 2010-096978

(51) Int. Cl. H04N 5/225

(52) U.S. Cl. 348/333.06; 348/E05.024

(57) ABSTRACT

A device includes a housing unit which includes a first housing, and a second housing which has a main-surface provided with a first display which displays an image, a second display which displays an operation unit, and accepts an instruction through operation of the displayed operation unit, and a detector which detects which of the main-surface and a rear-surface is exposed to outside in a state where the housing unit is folded with the first and second housings being placed on each other. The second display is positioned on a surface of the housing unit exposed to outside in the folded state. The operation unit to be displayed on the second display is switched to either a display operation unit which accepts an instruction for image display, or a sound recording operation unit which accepts an instruction for sound recording, based on detection from the detector.

This nonprovisional application is based on Japanese Patent Application No. 2010-096978 filed on Apr. 20, 2010, with the Japan Patent Office, the entire contents of which are hereby incorporated by reference.

### BACKGROUND OF THE INVENTION

1. Field of the Invention

The present invention relates to a recording and reproducing device, and more particularly to a recording and reproducing device capable of recording and reproducing information including image and sound.

2. Description of the Related Art

Various types of portable communication equipment for recording and reproducing information including image and sound have been conventionally proposed. In some of these types of communication equipment, a communication equipment body is divided into three members, which are rotatably coupled to one another via a universal joint. An upper divided member includes an electronic camera, a central divided member includes a display for displaying an image picked up by the electronic camera, and a lower divided member includes a microphone.

Such communication equipment has, on the display provided on the central divided member, a touch-sensitive function for accepting various types of operations for a picked-up image or a call, image pickup/sound recording, image pickup, sound recording and transmission. Depending on the degree of inclination of each divided member, therefore, it is difficult for a user to operate various types of keys via a touch sensor displayed on the display.

### SUMMARY OF THE INVENTION

A recording and reproducing device which records and reproduces information which includes image and sound according to the present invention includes a housing unit which includes a first housing, and a second housing which has a main surface provided with a first display unit which displays an image, a coupling unit which connects the first housing to the second housing such that they can be placed on each other, a second display unit which displays an operation unit, and accepts an instruction through operation of the displayed operation unit, and a surface detection unit which detects which of the main surface and a rear surface opposite to the main surface is exposed to outside in a state where the housing unit is folded with the first housing and the second housing being placed on each other via the coupling unit.

The second display unit is positioned on a surface of the housing unit exposed to outside in the folded state of the housing unit. The recording and reproducing device switches the operation unit to be displayed on the second display unit to either a display operation unit which accepts an instruction for image display operation, or a sound recording operation unit which accepts an instruction for sound recording operation, based on detection from the surface detection unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A to 1D are external views of a recording and reproducing device according to an embodiment of the present invention.

FIG. 2 shows an example of display of a reproduction operation unit according to the embodiment of the present invention.

FIG. 3 is a perspective view in which a second housing according to the embodiment of the present invention has been raised.

FIG. 4 is a perspective view in which the second housing according to the embodiment of the present invention has been rotated.

FIG. 5 is a perspective view seen from the main surface side of the second housing according to the embodiment of the present invention.

FIG. 6 is a perspective view in which the second housing according to the embodiment of the present invention has been rotated.

FIG. 7 is a perspective view in which a rear surface of the second housing according to the embodiment of the present invention faces outside.

FIG. 8 is a perspective view in which the main surface of the second housing according to the embodiment of the present invention faces outside.

FIG. 9 is a functional configuration diagram of the recording and reproducing device according to the embodiment of the present invention.

FIG. 10 is a process flowchart in the recording and reproducing device according to the embodiment of the present invention.

### DESCRIPTION OF THE PREFERRED EMBODIMENTS

An embodiment of the present invention will be described hereinafter with reference to the drawings. It is noted that the same reference characters indicate the same or corresponding components throughout the drawings.

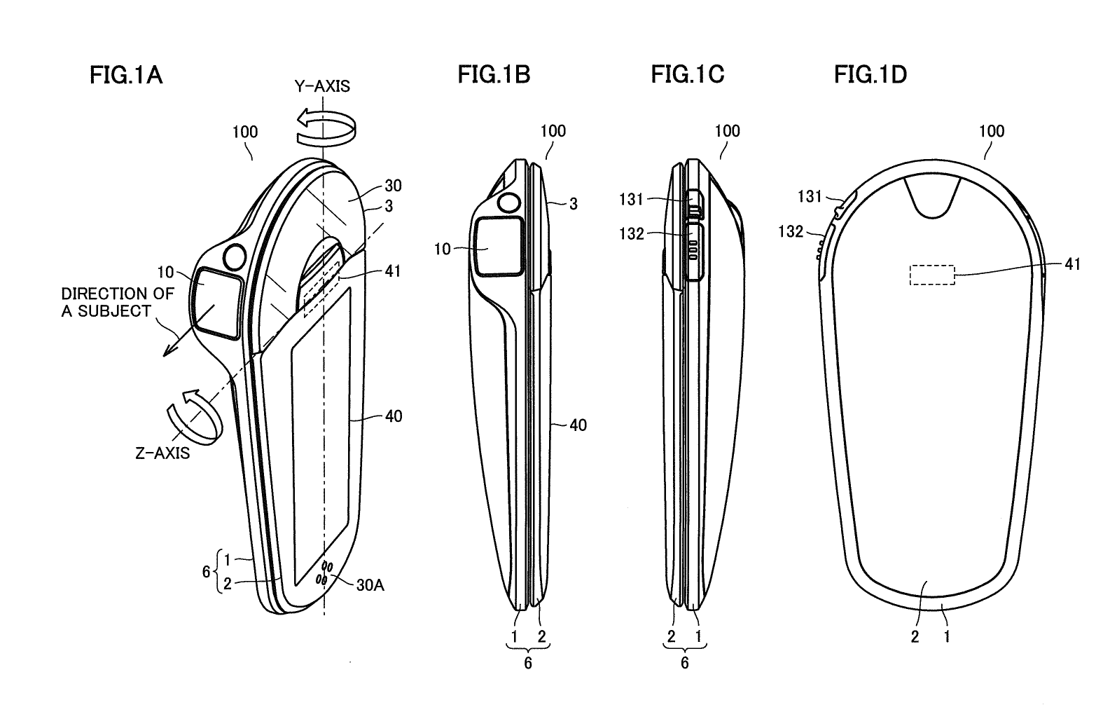

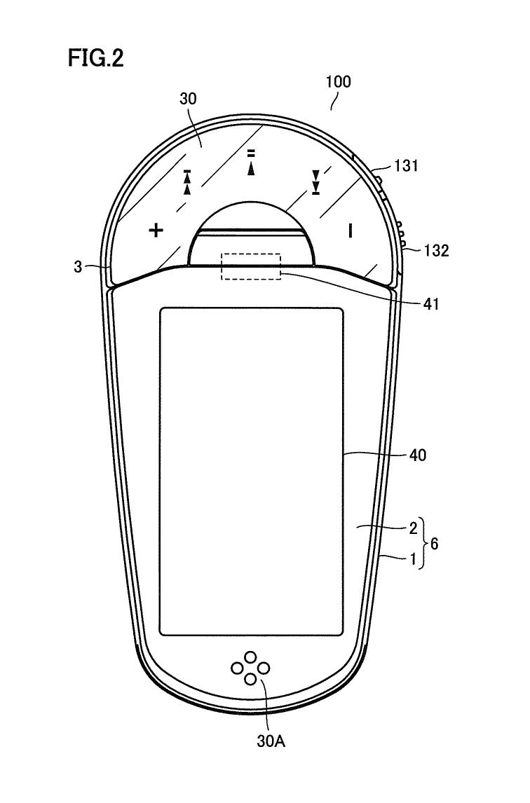

FIG. 1A is an external perspective view, FIG. 1B is a left side view, FIG. 1C is a right side view, and FIG. 1D is a rear view, in which a housing unit of a recording and reproducing device according to the present embodiment has been folded. A body 6 which is the housing unit of a recording and reproducing device 100 includes a first housing 1 and a second housing 2.

Second housing 2 includes a first display unit 40 and a speaker 30A for outputting reproduced sound on a main surface of the housing, and further includes a microphone (a microphone 30B to be described later) corresponding to a sound collecting unit for sound recording on a rear surface of the housing opposite to the main surface. First housing 1 includes an image pickup lens 10 to be oriented in a direction of a subject, for image pickup. Recording and reproducing device 100 includes a coupling unit 41 corresponding to a hinge mechanism for connecting second housing 2 to first housing 1 such that they can be placed on each other. Body 6 is configured such that it can be folded by placing second housing 2 on first housing 1 via coupling unit 41. First housing 1 includes, on a surface 3 exposed to outside with second housing 2 being placed on first housing 1, a second display unit 30 for displaying an image of an operation unit (such as switches and buttons) for accepting operation input from a user.

First display unit 40 is formed of a liquid crystal display, for example. Second display unit 30 is formed of a touch panel which is a display-integrated input device. The touch panel includes a display device such as a liquid crystal panel and a locator device such as a touch pad, which are integrated with each other. By touching (pressing) a display image on a screen via the touch pad, a touching position is read by the touch-sensitive function, and data or operation/instruction corresponding to the display image is input.

In the folded state, surface 3 including second display unit 30 is positioned on extension of the surface (the main surface or the rear surface) of second housing 2 exposed to outside. That is, surface 3 and the exposed surface are disposed to be positioned in different areas in the same plane. Accordingly, the user can readily operate the operation unit displayed on second display unit 3 while watching a display screen on first display unit 40.

On a side surface of first housing 1, switches 131 and 132 operated to pick up an image of a subject through image pickup lens 10 are provided (see FIG. 1C). Switch 131 corresponds to a shutter key. Switch 132 is pressed to indicate start of picture recording, and pressed again to indicate end of picture recording after the start of picture recording. Switch 132 can be operated to slide along the side surface of first housing 1, and the sliding operation allows switching of a zoom range.

FIG. 1A shows an imaginary Z-axis extending in parallel with a short side of second housing 2, and an imaginary Y-axis extending in parallel with a long side of second housing 2. The Z-axis and the Y-axis are orthogonal to each other. Referring to FIG. 1A, second housing 2 is attached to first housing 1 via coupling unit 41 in a manner rotatable around the Z-axis. Second housing 2 is rotated around the Z-axis, and is consequently raised to be almost perpendicular to first housing 1. In an opened state where second housing 2 has been rotated around the Z-axis (not in the folded in state), second housing 2 is attached to first housing 1 via coupling unit 41 in a manner rotatable around the Y-axis, thus attaining the so-called swiveling function. As such, coupling unit 41 functions as a support member for supporting rotations of second housing 2 around the Z-axis and the Y-axis.

Recording and reproducing device 100 according to the present embodiment has a surface detection function of detecting which of the main surface (the surface including first display unit 40) and the rear surface (the surface including microphone 30B to be described later) of second housing 2 is exposed to outside in the folded state. Based on a detection result with the surface detection function, recording and reproducing device 100 switches between an image of a reproduction operation unit for accepting input of image reproduction operation, and an image of a sound recording operation unit for accepting input of sound recording operation, as an image to be displayed on second display unit 30.

As a result, the user can perform image reproduction operation by touching the image of the reproduction operation unit (the image of switches or buttons) displayed on second display unit 30 via the touch pad while watching an image reproduced and displayed via first display unit 40. In addition, the user can perform sound recording operation by touching the image of the sound recording operation unit (the image of switches or buttons) displayed on second display unit 30 via the touch pad while recording sound via microphone 30B.

In FIG. 2, when the rear surface of second housing 2 is positioned on the inner surface side and the main surface of second housing 2 is positioned on the outer surface (exposed surface) side in the folded state, second display unit 30 displays the image of the reproduction operation unit for reproducing and displaying an image on first display unit 40 on the exposed surface (the main surface). As the image of the reproduction operation unit, an image of various types of buttons for accepting input of image reproduction operation (operation buttons for fast-forward/reverse, for volume adjustment (plus and minus signs), for start/stop of reproduction, and the like) is displayed. The user inputs an operation instruction by touching the operation buttons displayed on second display unit 30 via the touch pad. The input operation instruction is accepted, and the image reproduction operation in first display unit 40 is controlled based on the accepted operation instruction.

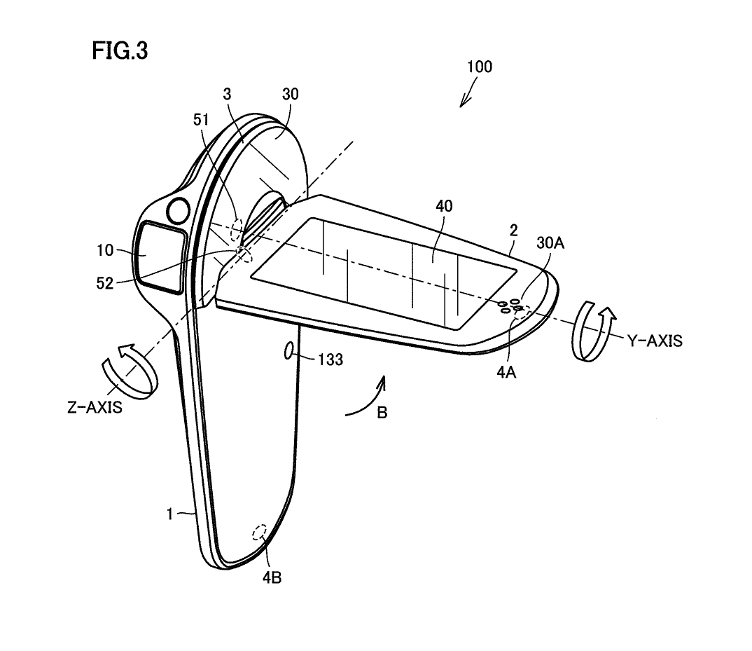

FIG. 3 shows a state where the user has rotated second housing 2 around the Z-axis in a direction of an arrow B from the state shown in FIG. 2, to raise second housing 2 to be almost perpendicular to first housing 1. When body 6 takes the posture shown in FIG. 3, a power source switch 133 provided on first housing 1 is exposed to outside.

Recording and reproducing device 100 includes, with regard to coupling unit 41, angle sensors 51 and 52 for detecting angles of rotation of second housing 2. Angle sensor 51 detects an angle of rotation of second housing 2 around the Y-axis, and angle sensor 52 detects an angle of rotation of second housing 2 around the Z-axis.

Referring to FIG. 3, recording and reproducing device 100 includes a magnet 4A provided on second housing 2, and a sensor 4B provided on first housing 1 for sensing a magnetic force of magnet 4A, in order to detect whether body 6 is opened or closed (folded or not). Magnet 4A and sensor 4B are provided in positions such that they face each other in the folded state. Based on output of sensing by sensor 4B, therefore, it can be determined whether body 6 is in the folded state (the state shown in FIG. 1 or 2) or not, namely, whether body 6 is opened or closed.

Further, based on outputs of detection by angle sensors 51 and 52, the angles of rotation of second housing 2 around the Z-axis and the Y-axis can be determined.

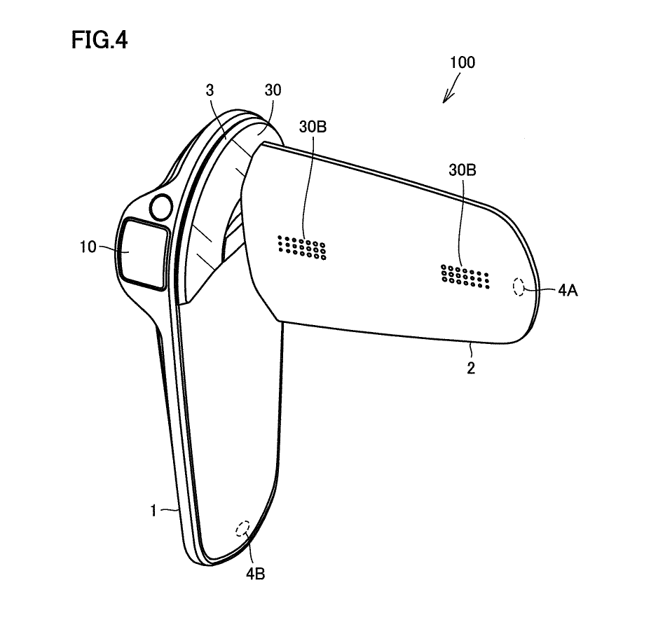

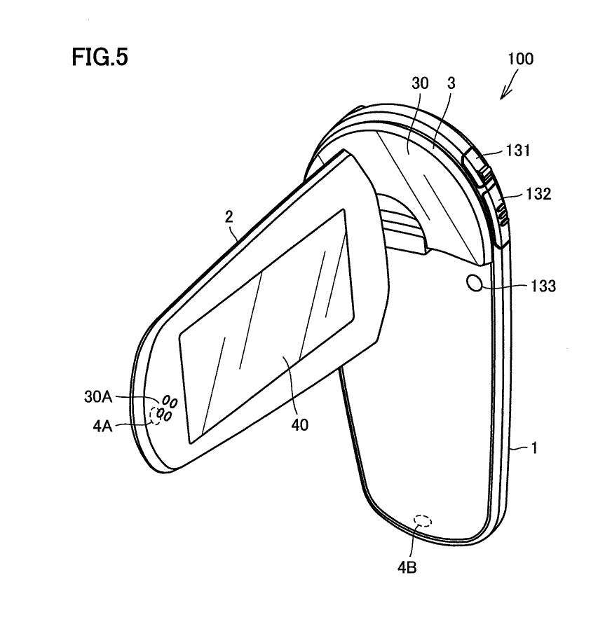

When the user rotates second housing 2 around the Y-axis from the posture shown in FIG. 3, a direction in which the rear surface (the surface including microphone 30B) of second housing 2 is oriented matches the direction in which image pickup lens 10 is oriented, as shown in FIG. 4. FIG. 5 shows the appearance viewed from the main surface side of second housing 2 in the state shown in FIG. 4. FIGS. 4 and 5 show a posture for picking up an image of a subject through image pickup lens 10. An image of the subject picked up through image pickup lens 10 oriented in the image pickup direction (the direction of the subject) is displayed in real time via first display unit 40, and so first display unit 40 functions as a viewfinder for a person picking up the image during image pickup. Further, in the posture shown in FIG. 4, a direction in which microphone 30B collects sound matches the image pickup direction (the direction of the subject), and so sound can be efficiently input together with the picked-up image.

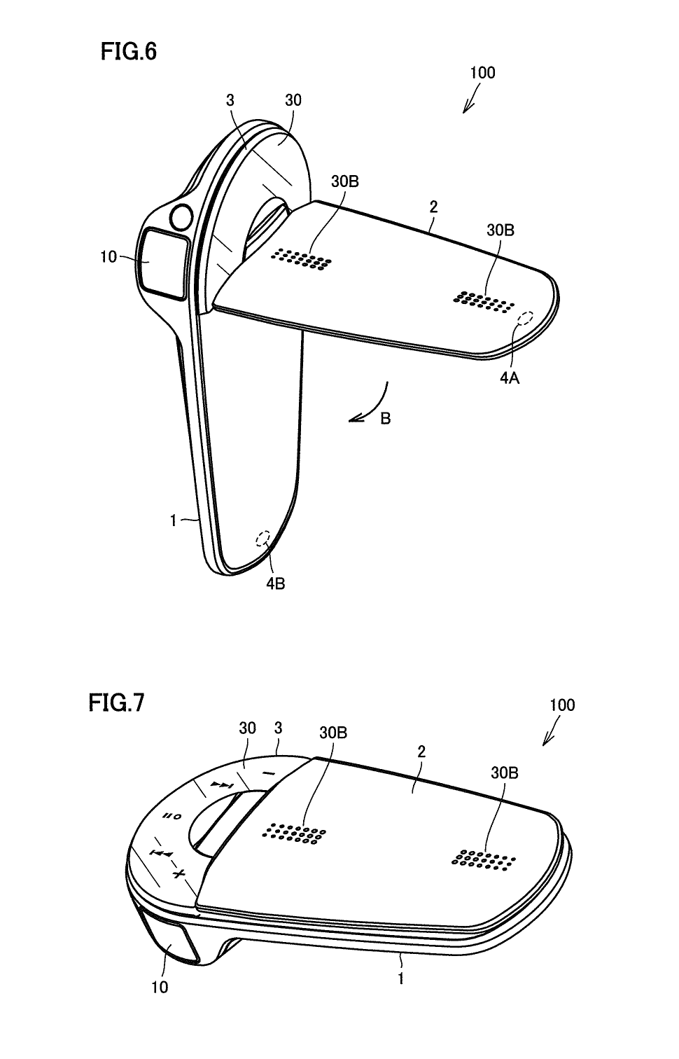

When the user rotates second housing 2 around the Y-axis from the posture shown in FIG. 4 (or FIG. 5), a state shown in FIG. 6 is attained. When the user rotates second housing 2 around the Z-axis in a direction of an arrow B from the posture shown in FIG. 6, body 6 is folded as shown in FIG. 7. In the state shown in FIG. 7, the main surface (the surface including first display unit 40) of second housing 2 is positioned on the inner surface side of folded body 6, and the rear surface (the surface including microphone 30B) is positioned to be exposed to outside.

In FIG. 7, microphone 30B is exposed to outside, and so can efficiently collect ambient sound. In the state shown in FIG. 7, second display unit 30 displays the image of the sound recording operation unit for sound recording via microphone 30B. As the image of the sound recording operation unit, an image of various types of buttons for accepting input of sound recording operation (operation buttons for switching a sound recording mode, for microphone sensitivity adjustment (plus and minus signs), for sound-activated recording (VCVA (Variable Control Voice Actuator) sound recording), for start/stop of sound recording, and the like) is displayed. The user inputs an operation instruction by touching the operation buttons on the image of the sound recording operation unit displayed on second display unit 30. The input operation instruction is accepted, and sound collecting operation and sound recording operation via microphone 30B is controlled based on the accepted operation instruction.

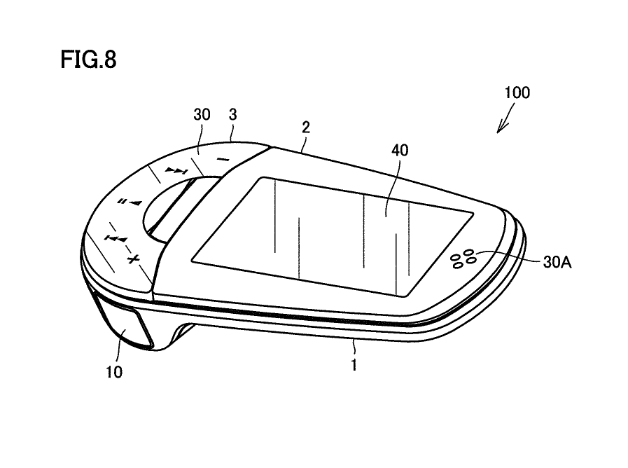

When the user rotates second housing 2 around the Z-axis and the Y-axis from the posture shown in FIG. 7, the posture of body 6 can be changed in the order of FIG. 7, FIG. 6, FIG. 4 (or FIG. 5), FIG. 3 and FIG. 2, to attain a posture shown in FIG. 8. In FIG. 8, second display unit 30 displays the image of the reproduction operation unit for reproducing and displaying an image on first display unit 40 (see FIG. 2).

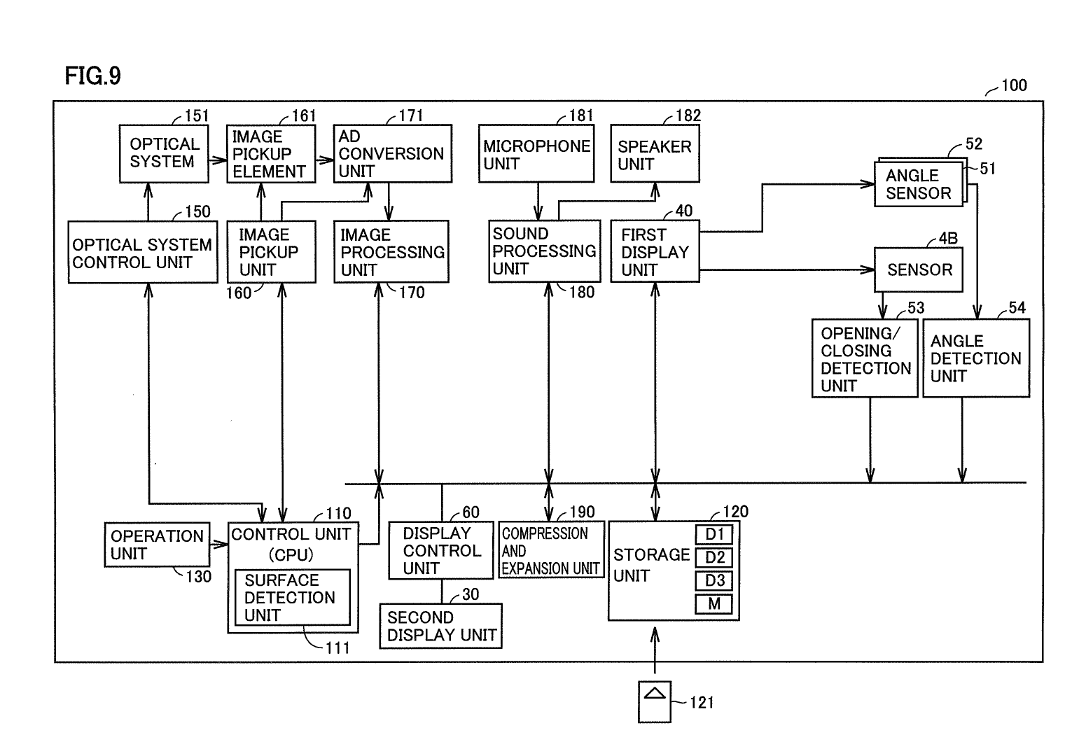

Referring to FIG. 9, a configuration of recording and reproducing device 100 according to the present embodiment is described.

Recording and reproducing device 100 includes a control unit 110, a storage unit 120, an operation unit 130 having switches 131, 132 and 133, first display unit 40, an optical system control unit 150 and an optical system 151 related to image pickup lens 10, an image pickup element 161 formed of a CCD (Charge Coupled Device) and an image pickup element control unit 160 for controlling image pickup element 161, an image processing unit 170, an AD (Analog Digital) conversion unit 171, a sound processing unit 180, a microphone unit 181 having microphone 30B, a speaker unit 182 including speaker 30A, and a compression and expansion unit 190.

Recording and reproducing device 100 further includes a display control unit 60 for controlling display operation of second display unit 30, an angle detection unit 54 for receiving detection signals from angle sensors 51 and 52 and detecting angles of rotation of second housing 2 around the Z-axis and the Y-axis based on the received detection signals, and an opening/closing detection unit 53 for receiving a detection signal from sensor 4B and detecting whether body 6 is opened or closed (folded or not) based on the received detection signal.

Display control unit 60 causes second display unit 30 to display an image based on image data for displaying the operation unit which is previously stored in a predetermined area of storage unit 120, or data supplied from control unit 110.

The angle detected by angle sensor 52 may be used instead of the output of sensing by sensor 4B. Based on the angle of rotation of second housing 2 around the Z-axis detected by angle sensor 52, it can be determined whether body 6 is in the folded state or in the opened state.

The units described above transmit and receive data/signals to and from one another via a transmission path such as a bus.

Storage unit 120 includes a non-volatile memory such as a ROM (Read Only Memory) (e.g., a flash memory) and a volatile memory such as a RAM (Random Access Memory) (e.g., an SDRAM (Synchronous Dynamic Random Access Memory)), and a memory card slot for reading and writing data from and into a removable card-like memory (hereinafter referred to as a memory card) 121 (e.g., an SD memory card and a USB (Universal Serial Bus) memory). By storing data about sound or image recorded or picked up with recording and reproducing device 100 in memory card 121, the recorded sound data or picked-up image data can be transferred to an external information processing device via memory card 121. The data transfer is not limited to that through a recording medium such as a memory card, but may be conducted through communication (wired or wireless) if recording and reproducing device 100 has the function of communicating with external equipment.

Storage unit 120 may include, in addition to or instead of the semiconductor memory such as the non-volatile memory and the volatile memory, another internal storage device such as a hard disc drive. In addition, storage unit 120 may include, in addition to or instead of the memory card slot, another external storage device such as a device for reading and writing data from and into a recording medium such as an optical disc (e.g., a DVD (Digital Versatile Disc) and a BD (Blue-ray Disc)).

Storage unit 120 stores data on a program for controlling recording and reproducing device 100, data for controlling recording and reproducing device 100, data for setting the various functions of recording and reproducing device 100, data on a still image or a moving image picked up by recording and reproducing device 100, data on sound collected by microphone unit 181, and the like.

Storage unit 120 is also used as a work memory during execution of a program, and as a buffer memory during image pickup processing.

Angle data D1, D2 and D3, and mode data M is previously stored in the predetermined storage area of storage unit 120.

Angle data D1 indicates angles detected by angle sensors 51 and 52 when body 6 is folded and the main surface of second housing 2 is exposed (FIGS. 2, 8 and the like). Angle data D2 indicates angles detected by angle sensors 51 and 52 when body 6 is folded and the rear surface including microphone 30B of second housing 2 is exposed (FIG. 7 and the like). Angle data D3 indicates angles detected by angle sensors 51 and 52 when body 6 is opened and takes the posture that allows second housing 2 to function as a viewfinder (FIGS. 4, 5 and the like). These pieces of angle data are previously detected by experiment and stored.

Mode data M indicates a current operation mode of recording and reproducing device 100. Recording and reproducing device 100 includes a plurality types of operation modes such as an image reproduction mode, a sound recording mode, and a picture recording mode for recording a picked-up image.

Control unit 110 includes a CPU (Central Processing Unit), and controls operation of each unit in accordance with a command code/data of the program for controlling recording and reproducing device 100 stored in storage unit 120. Control unit 110 controls each unit in accordance with an operation mode that has been set, based on data that has been set by mode data M. In this manner, the operation mode of recording and reproducing device 100 is switched.

Control unit 110 includes a surface detection unit 111 corresponding to the function of surface detection processing to be described later. Surface detection unit 111 is constituted of a program, but may be constituted of a combination of a program and a circuit.

Recording and reproducing device 100 is a computer including the CPU in control unit 110 having a versatile architecture, and provides various functions including the processing in a flowchart to be described later by executing a previously installed program. When such versatile computer is employed, an OS (Operating System) for providing basic function of a computer may be installed in addition to an application for providing the functions according to the present embodiment. In this case, the program according to the present embodiment may be such that processing is performed by calling a necessary module from a program module provided as part of the OS in a predetermined arrangement at predetermined timing. That is, the program itself according to the present embodiment does not include the module as described above, but is executed in cooperation with the OS. The program according to the present embodiment may not include such partial module.

Moreover, the program according to the present embodiment may be provided as incorporated into a part of another program. Again in this case, the program itself does not include a module included in another combined program as described above, but is executed in cooperation with the another program. Namely, the program according to the present embodiment may be incorporated into such another program.

The functions provided by execution of the program may be partially or entirely incorporated as a dedicated hardware circuit.

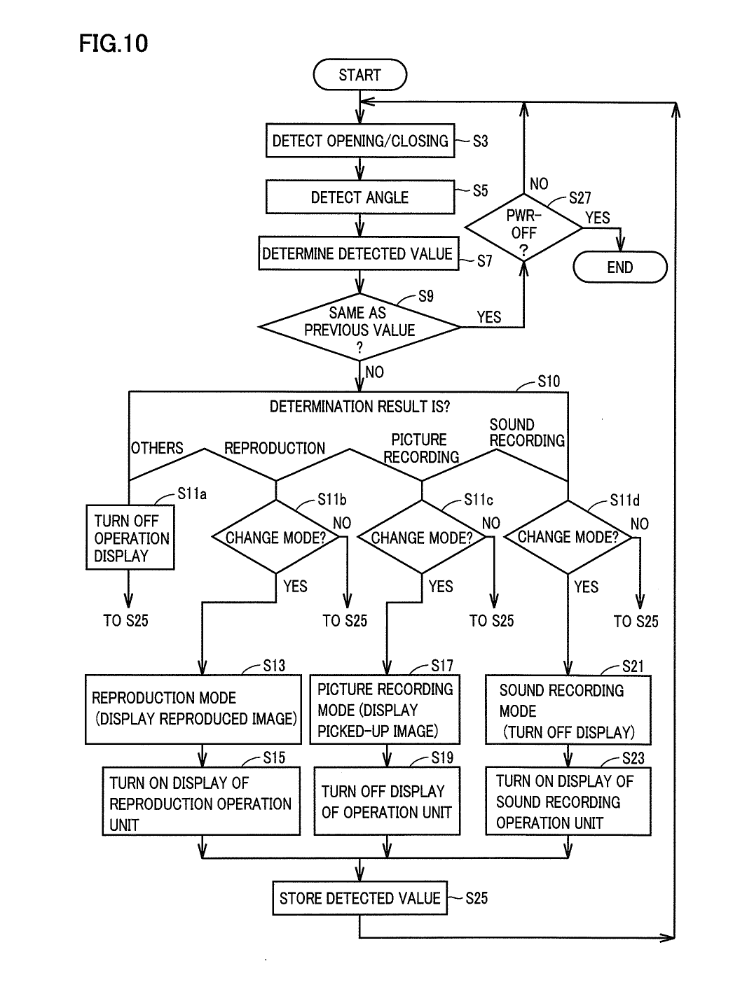

Referring to a flowchart of FIG. 10, the processing of display control in second display unit 30 according to the present embodiment is described.

When power is turned on by operation of power source switch 133, control unit 110 detects whether body 6 is in the folded state (closed state) or in the opened state by opening/closing detection unit 53 (step S3). Then, control unit 110 detects angles of rotation of second housing 2 which are output from angle sensors 51 and 52 by angle detection unit 54 (step S5). These detected values are stored in the predetermined area of storage unit 120 upon each detection (see step S25 to be described later).

Control unit 110 compares the detected values of the opened/closed state and of the angles of rotation detected this time with previous detected values stored in storage unit 120 (step S7), and determines whether or not this time's detected values are the same as the previous detected values based on a comparison result (step S9). If it is determined that this time's detected values are the same as the previous detected values (YES at step S9), it is determined whether or not power has been turned off by operation of power source switch 133 (step S27). If it is determined that power has been turned off (YES at step S27), power supply to each unit is cut off, and the process ends.

If it is determined that power has not been turned off (NO at step S27), the process returns to step S3, and the subsequent processing is performed in a similar manner.

On the other hand, if it is determined that the detected values of the opened/closed state and of the angles of rotation of second housing 2 around the Z-axis and the Y-axis detected this time are not the same as the previous detected values (NO at step S9), the detected values of the opened/closed state and of the angles of rotation of second housing 2 around the Z-axis and the Y-axis are compared with the values indicated by angle data D1 to D3 read from storage unit 120, respectively. Then, based on a comparison result, the image of the operation unit to be displayed on second display unit 30 is switched (step S10). Step S10 corresponds to the surface detection processing by surface detection unit 111 for detecting which of the main surface and the rear surface of second housing 2 is exposed to outside when body 6 is folded.

Specifically, if it is determined that the detected values of the opened/closed state and of the angles of rotation indicate the values of angle data D1 based on the comparison result (“reproduction” at step S10), it is determined whether or not it is necessary to change setting of the operation mode in order to switch the operation mode to the image reproduction mode (step S11b). That is, it is determined whether or not the current operation mode indicated by mode data M indicates the “image reproduction mode,” and if it is determined that it does not indicate the image reproduction mode (YES at step S11b), the operation mode is switched to the image reproduction mode (step S13). Then, mode data M is updated to indicate the image reproduction mode. In the image reproduction mode, first display unit 40 displays an image read from storage unit 120 (step S13). Second display unit 30 displays an image of an image reproduction operation unit by display control unit 60 under control of control unit 110 (step S15).

If it is determined that the current operation mode indicated by mode data M indicates the “image reproduction mode” (NO at step S11b), the processing proceeds to step S25 to be described later, without changing the operation mode and the image of the operation unit displayed on second display unit 30.

On the other hand, if it is determined that the detected values of the opened/closed state and of the angles of rotation indicate the values of angle data D2 based on the comparison result (“sound recording” at step S10), it is determined whether or not it is necessary to change setting of the operation mode in order to switch the operation mode to the sound recording mode (step S11d). That is, it is determined whether or not the current operation mode indicated by mode data M indicates the “sound recording mode,” and if it is determined that it does not indicate the sound recording mode, the operation mode is switched to the sound recording mode (step S21). Then, mode data M is updated to indicate the sound recording mode. In the sound recording mode, data on sound collected by microphone 30B is stored in the predetermined storage area of storage unit 120 (step S21). In the sound recording mode, first display unit 40 does not display an image because power is not supplied to first display unit 40, and second display unit 30 displays the image of the sound recording operation unit by display control unit 60 under control of control unit 110 (step S21).

If it is determined that the current operation mode indicated by mode data M indicates the “sound recording mode” (NO at step S11d), the processing proceeds to step S25 to be described later, without changing the operation mode and the image of the operation unit displayed on second display unit 30.

If it is determined that the detected values of the opened/closed state and of the angles of rotation indicate the values of angle data D3 based on the comparison result (“picture recording” at step S10), it is determined whether or not it is necessary to change setting of the operation mode in order to switch the operation mode to the picture recording mode (step S11c). That is, it is determined whether or not the current operation mode indicated by mode data M indicates the “picture recording mode,” and if it is determined that it does not indicate the picture recording mode (YES at step S11c), the operation mode is switched to the picture recording mode (step S17). Then, mode data M is updated to indicate the picture recording mode. In the picture recording mode, an image of a subject input through image pickup lens 10 is displayed on first display unit 40 (step S17), and stored in the predetermined area of storage unit 120. In the picture recording mode, second display unit 30 does not display the image of the operation unit because power is not supplied to second display unit 30 (step S19).

If it is determined that the current operation mode indicated by mode data M indicates the “picture recording mode” (NO at step S11c), the processing proceeds to step S25 to be described later, without changing the operation mode and the image of the operation unit displayed on second display unit 30.

If it is determined that the detected values of the opened/closed state and of the angles of rotation do not indicate any of the values of angle data D1 to D3 based on the comparison result (“others” at step S10), the operation mode is not changed, and power supply to second display unit 30 is cut off to turn off the display (if the display has already been turned off, the process for turning off the display is not performed). Then, the process proceeds to step S25 to be described later.

At step S25, control unit 110 stores the values detected this time at step S3 and step S5 in the predetermined area of storage unit 120. Then, the processing returns to step S3, and the subsequent processing is performed in a similar manner.

In the flowchart of FIG. 10, the process of step S25 may be performed after the detection processes of step S3 and step S5.

### Other Embodiments

In the embodiment described above, second display unit 30 may display information about image reproduction operation and sound recording operation (information such as a date on which a reproduced image was recorded, the remaining amount of memory for sound recording, or microphone sensitivity) simultaneously with or separately from the image of the operation unit (the image of switches or buttons).

In addition, while body 6 includes two housings, i.e., first housing 1 and second housing 2, body 6 may include three more housings.

Further, the recorded sound data may be reproduced and output via speaker 30A on the main surface of second housing 2, with body 6 being placed as shown in FIG. 2. In this case, first display unit 40 may display information about sound reproduction operation (such as a file name of reproduced sound, the remaining amount of reproduced data, or a speaker volume).

Furthermore, a speaker may be provided on the rear surface of second housing 2. In this case, sound may be reproduced and output, with body 6 being placed to expose the speaker on the rear surface to outside, as shown in FIG. 7. During sound reproduction and output in this case, second display unit 30 displays an image of an operation unit for sound reproduction (switches or buttons). In addition, second display unit 30 may display the information about sound reproduction operation described above simultaneously with or separately from the image of the operation unit.

While second display unit 30 does not display an image during the picture recording mode in the embodiment described above, second display unit 30 may display an image of an operation unit for recording operation and image pickup operation for picture recording (such as switches for luminance adjustment, and for determining presence or absence of camera shake correction and still image/moving image). In addition, second display unit 30 may display information about picture recording operation or image pickup operation (such as information about brightness of a subject, and focus adjustment information) simultaneously with or separately from the image of the operation unit.

Moreover, the various types of programs including the program according to the process flowchart of FIG. 10 described in the above embodiment are stored in a recording medium readable by a machine such as a computer. The recording medium may be one of various types of storage media such as the CD-ROM, the ROM, the RAM and memory card 121 applied to storage unit 120, for example. Alternatively, the program may be provided through download via a network.

According to the present embodiment, based on the detection result from the surface detection unit, recording and reproducing device 100 switches between the image of the reproduction operation unit for accepting input of image reproduction operation, and the image of the sound recording operation unit for accepting input of sound recording operation, as an image to be displayed on second display unit 30. As a result, the user can perform image reproduction operation by operating the image of the reproduction operation unit displayed on second display unit 30 while watching an image reproduced and displayed via first display unit 40. In addition, the user can perform sound recording operation by touching the image of the sound recording operation unit displayed on second display unit 30 while recording sound via the sound collecting unit (microphone unit 181), thereby attaining excellent operability.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A recording and reproducing device which records and reproduces information which includes image and sound, comprising:
a housing unit which includes a first housing, and a second housing which has a main surface provided with a first display unit which displays an image;
a coupling unit which connects said first housing to said second housing such that they can be placed on each other;
a second display unit which displays an operation unit, and accepts an instruction through operation of the displayed operation unit; and
a surface detection unit which detects which of said main surface and a rear surface opposite to the main surface is exposed to outside in a state where said housing unit is folded with said first housing and said second housing being placed on each other via said coupling unit,
said second display unit being positioned on a surface of said housing unit exposed to outside in the folded state of said housing unit, and
said operation unit to be displayed on said second display unit being switched to either a display operation unit which accepts an instruction for image display operation, or a sound recording operation unit which accepts an instruction for sound recording operation, based on detection from said surface detection unit.

2. The recording and reproducing device according to claim 1, further comprising a sound collecting unit which collects sound to be recorded on said rear surface.

3. The recording and reproducing device according to claim 1, wherein
said first display unit displays a reproduced image, and
said display operation unit includes a reproduction operation unit which accepts an instruction for image reproduction operation.

4. The recording and reproducing device according to claim 1, comprising said second display unit on a surface of said first housing exposed to outside in said folded state.

5. The recording and reproducing device according to claim 1, wherein
the exposed surface which includes said second display unit, and one of said main surface and said rear surface exposed to outside are included in the same plane in said folded state.

6. The recording and reproducing device according to claim 1, wherein
said first display unit displays a picked-up image, and
said display operation unit includes an image pickup operation unit which accepts an instruction for operation regarding the picked-up image displayed on said first display unit.

7. The recording and reproducing device according to claim 6, wherein
said image pickup operation unit includes a recording operation unit which accepts an instruction for recording of said picked-up image.

8. The recording and reproducing device according to claim 1, wherein
said second display unit displays either information about image display operation or information about sound recording operation based on detection from said surface detection unit in said folded state.

9. The recording and reproducing device according to claim 1, wherein
said recording and reproducing device has operation modes which includes an image reproduction mode and a sound recording mode, and
an operation mode of said recording and reproducing device is set to either said image reproduction mode or said sound recording mode based on detection from said surface detection unit.

10. The recording and reproducing device according to claim 1, wherein
said first housing includes an image pickup lens, and
said first display unit displays an image picked up through said image pickup lens, in a state where said housing unit is opened.

11. The recording and reproducing device according to claim 1, comprising a sound output unit which outputs sound on said main surface of said second housing.

12. A method for controlling a recording and reproducing device which records and reproduces information which includes image and sound, said recording and reproducing device including
a housing unit which includes a first housing, and a second housing which has a main surface provided with a first display unit which displays an image,
a coupling unit which connects said first housing to said second housing such that they can be placed on each other, and
a second display unit which displays an operation unit, and accepts an instruction through operation of the displayed operation unit,
said second display unit being positioned on a surface of said housing unit exposed to outside in a state where said housing unit is folded with said first housing and said second housing being placed on each other via said coupling unit, said method comprising the steps of:
detecting which of said main surface and a rear surface opposite to the main surface is exposed to outside in the folded state; and
switching said operation unit displayed on said second display unit to either a display operation unit which accepts an instruction for image display operation, or a sound recording operation unit which accepts an instruction for sound recording operation, based on detection at said detecting step.

13. A machine-readable recording medium which records a program which causes a processor to perform a method for controlling a recording and reproducing device which records and reproduces information which includes image and sound, said recording and reproducing device including
a housing unit which includes a first housing, and a second housing which has a main surface provided with a first display unit which displays an image,
a coupling unit which connects said first housing to said second housing such that they can be placed on each other, and
a second display unit which displays an operation unit, and accepts an instruction through operation of the displayed operation unit,
said second display unit being positioned on a surface of said housing unit exposed to outside in a state where said housing unit is folded with said first housing and said second housing being placed on each other via said coupling unit, said method comprising the steps of:
detecting which of said main surface and a rear surface opposite to the main surface is exposed to outside in the folded state; and
switching said operation unit to be displayed on said second display unit to either a display operation unit which accepts an instruction for image display operation, or a sound recording operation unit which accepts an instruction for sound recording operation, based on detection at said detecting step.
